(19) United States
(12) Patent Application Publication
(10) Pub. No.: US 2026/0035248 A1
(43) Pub. Date: Feb. 5, 2026

(54) PROCESS FOR CONVERTING A SOLID CARBON SOURCE TO GRAPHITE

(71) Applicants: The Regents of the University of California, Oakland, CA (US); The Penn State Research Foundation, University Park, PA (US)

(72) Inventors: Reza Abbaschian, Riverside, CA (US); Steven Herrera, Riverside, CA (US); Dane Boysen, Spokane, WA (US); Hojong Kim, University Park, PA (US)

(73) Assignees: The Regents of the University of California, Oakland, CA (US); The Penn State Research Foundation, University Park, PA (US)

(21) Appl. No.: 18/994,430

(22) PCT Filed: Jul. 13, 2023
(86) PCT No.: PCT/US2023/027650

§ 371 Date: Jan. 14, 2025

Related U.S. Application Data
(60) Provisional application No. 63/389,300, filed on Jul. 14, 2022.

(51) Int. Cl. C01B 32/205; B01J 19/00; B01J 19/14; B01J 19/24

(52) U.S. Cl. CPC C01B 32/205; B01J 19/0013; B01J 19/14; B01J 19/2415; B01J 2219/00081; B01J 2219/00159; B01J 2219/00745; C01P 2002/72; C01P 2006/80

(57) ABSTRACT

The invention provides methods and apparatuses for converting a solid carbon source to graphite by precipitation from a molten metal (e.g., molten iron) as well as graphite prepared from the methods and apparatuses.

### PRIORITY

This application claims priority to U.S. Provisional Application No. 63/389,300, filed 14 Jul. 2022. The entire contents of this United States Provisional Patent Application are hereby incorporated herein by reference.

### BACKGROUND

Increasing electric vehicle sales (2.6% market share in 2019) are driving a massive increase in global lithium-ion battery production capacity and in-turn wreaking havoc upon traditional graphite market supply chains. Lithium-ion batteries today use about 1.2 kg/kWh of coated spherical graphite per storage capacity, so a typical 75 kWh-electric vehicle will contain about 90 kg of graphite. In 2019, the production of 2.1 million electric vehicles required 190,000 t spherical coated graphite, 480,000 t large-flaked natural graphite (˜2.5×spherical), and 960,000 t mined natural graphite (˜2×flake)—note that about 80% of mined natural graphite ends up as secondary graphite fines. Why natural graphite? it is cheaper (8,000 $/t versus 13,000 $/t for synthetic graphite) and has better performance (higher capacity retention). Consequently, over the last 15 years battery manufacturers have shifted from using about 75% synthetic to 65% natural graphite. This shift has driven a global stampede to develop more than 40 new natural graphite mines worldwide, adding 1.9 Mt of new graphite capacity and 1.5 Mt of secondary graphite fines looking to cannibalize existing markets. What this all means is that secondary natural graphite fines are poised to price petcoke-derived synthetic graphite out of the market and into low-value heating fuels—resulting in an increase of up to 10 Mt CO₂ a year in greenhouse gas emissions.

Conventional synthetic graphite production uses electricity to heat pressed petcoke compacts to over 2800° C. for 2-3 weeks to overcome the high activation barrier and slow rate of solid-state atomic carbon reorganization (Eₐ˜680 KJ/mol and D˜1.0×10⁻¹² cm²/s at 2350° C.) to form thermodynamically favorable crystalline graphite—resulting in about 22 GJ/t of energy consumption, 4.4 t/t CO₂ emissions, and a production cost over 13,000 $/t synthetic graphite.

Petroleum coke is currently purified via calcination to remove moisture, drive off volatile matter and produce anode-grade coke at the desired level of real density with the highest purity, high physical strength and conductivity, minimum porosity and reactivity. The calcination process is carried out at temperatures up to 1200-1400° C. at contact times of 0.5 to 48 hours, depending on the nature of the petroleum coke and the process. There are currently three kinds of continuous calcination processes for petcoke: rotary kiln, rotary hearth, and vertical shaft furnace. Even at high temperatures, these processes still result in 1 wt % sulfur which drastically hinders performance. Evolved gases with these processes result in “puffing,” which is increased porosity, lower density, higher air reactivity, and lower mechanical strength, electrical conductivity, and thermal conductivity. Currently there is a need for improved methods for producing graphite. In particular, there is a need for methods for economically producing graphite that meets market specifications for purity, crystallinity, and conductivity.

### SUMMARY

Applicant has discovered an improved method that is more environmentally friendly for economically preparing graphite that meets market specifications for purity, crystallinity, and conductivity. Accordingly, in one embodiment, the invention provides a method for preparing graphite comprising:
a) adding a solid carbon source to a molten metal to provide a solution that comprises dissolved carbon at a first temperature;
b) reducing the temperature of all or part of the solution under conditions that allow graphite to form; and
c) isolating the graphite.

In another embodiment, the invention provides a method for preparing graphite comprising:
providing a molten metal having a temperature gradient that comprises a hot zone having a first temperature and a cooler zone having a second temperature that is below the temperature of the hot zone;
adding a solid carbon source into the hot zone; and
isolating graphite that forms in the cooler zone.

In another embodiment, the invention provides a method for preparing graphite comprising:
maintaining a first chamber at a first temperature;
maintaining a second chamber at a second temperature that is below the first temperature, the second chamber having a path to the first chamber;
adding a solid carbon source to molten metal in the first chamber to provide a solution;
allowing the solution to pass through the path from the first chamber to the second chamber; and
isolating graphite from the second chamber.

In some aspects of the invention, a molten metal (e.g. iron, nickel and their alloys) alloy is used as an effective separator to remove impurities from petcoke to yield high purity graphite, which is in contrast to processes wherein graphite is a byproduct (waste) of steelmaking rather than an on-purpose product. The low density of graphite (2.27 g/cm³) relative to molten iron (7.01 g/cm³) makes it easy to separate in situ, for example, by introducing an inert carrier gas (N₂ or Ar) at superficial velocities (e.g., 20-30 m/s) that can separate, fluidize, and transport the graphite particles (dₚ<10 mm) as shown in FIG. 1b.

Consistent with the disclosed embodiments, an apparatus for converting a solid carbon source to a highly crystalline graphite is disclosed. The apparatus comprises a tube having a horizontal tube axis, a crucible, and a heating unit. The crucible has a horizontal crucible axis substantially aligned with the horizontal tube axis. The crucible has a first crucible end and a second crucible end. The crucible is positioned substantially within the tube. The crucible to hold a metal and the solid carbon source. The heating unit to generate a temperature gradient along the horizontal crucible axis. The temperature gradient to decrease from the first crucible end to the second crucible end. And the highly crystalline graphite to be produced at the second crucible end.

In some embodiments, the apparatus further comprises a gas source coupled to the tube to supply an inert gas to the tube. In some embodiments, the tube comprises quartz. In some embodiments, the heating unit comprises a refractory brick thermally coupled to the crucible and an induction heating coil inductively coupled to the refractory brick. The tube is located substantially within the induction heating coil.

Consistent with the disclosed embodiments, an apparatus for converting a solid carbon source to a highly crystalline graphite is disclosed. The apparatus comprises a reactor including a vessel and a carbon heating element. The vessel has a first input port to receive nitrogen and the carbon heating element is included to provide energy to liquify the metal for the solid carbon source. A second input port is provided to receive the solid carbon source, and an output port is provided to deliver as output nitrogen and the highly crystalline graphite. The vessel also holds a solid metal to be liquified. The apparatus further includes a vessel heating unit to provide a temperature gradient within the vessel.

In some embodiments, the vessel heating unit provides the temperature gradient having a temperature from about 1700 degrees Centigrade at a high temperature section of the vessel to about 1300 degrees Centigrade at a low temperature section of the vessel. In some embodiments, the low temperature section of the vessel is closer to the output port than the high temperature section of the vessel.

### BRIEF DESCRIPTION OF THE DRAWINGS

FIGS. 1A-1B show: (FIG. 1A) a carbon-iron binary phase diagram indicating the pathway of the process; and (FIG. 1B) a conceptual diagram of the process.

FIGS. 2A-2D illustrate a flow-through reactor that can be used to carry out the methods of the invention.

FIG. 3 shows an illustration of an apparatus for converting a solid carbon source to highly crystalline graphite in accordance with some embodiments of the present disclosure.

FIG. 4 shows an illustration of an apparatus for converting a solid carbon source to a highly crystalline graphite in accordance with some embodiments of the present disclosure.

FIGS. 5A-5B compare X-ray diffraction pattern for graphite feed stock (commercial graphite for FIG. 5A and amorphous carbon for FIG. 5B) with those of highly crystalline graphite produced by the current invention.

FIGS. 6 shows a picture of graphite foil that was produced at the surface of nickel melt with the furnace shown in FIGS. 2A-2D.

FIG. 7 shows an illustration of an apparatus for converting a solid carbon source to highly crystalline graphite in accordance with some embodiments of the present disclosure.

### DETAILED DESCRIPTION

As used herein, the term “solid carbon source” includes any suitable source of carbon for use in the methods or apparatuses of the invention. In one embodiment, the solid carbon source comprises petroleum coke (e.g., petcoke), coal, charcoal, graphite fines, or amorphous or glassy carbon. The term includes solid and liquid sources of carbon-but excludes gaseous sources of carbon.

In one embodiment, the graphite product is at least 99% carbon. In one embodiment, the graphite comprises at least 95% graphite crystals. In one embodiment, the graphite comprises at least 98% graphite crystals. In one embodiment, the graphite comprises at least 99% graphite crystals. In one embodiment, the graphite that is at least 99% carbon and comprises at least 95% graphite crystals. In one embodiment, the graphite that is at least 99% carbon and comprises at least 98% graphite crystals. In one embodiment, the graphite is at least 99% crystalline graphite

The “molten metal” includes any molten metal that is suitable for use in the methods or apparatuses of the invention. In one embodiment, the molten metal comprises iron, silicon, nickel, copper, germanium, manganese, bismuth or silver, or a mixture thereof. In one embodiment, the molten metal is a molten iron alloy. In one embodiment, the molten metal comprises iron, silicon, or nickel, or a mixture thereof.

In one embodiment, the solid carbon source is added to the molten metal at a temperature of less than about 2000° C. In one embodiment, the solid carbon source is added to the molten metal at a temperature of less than about 1700° C. In one embodiment, the graphite forms at a temperature of less than about 1500° C. In one embodiment, the graphite forms at a temperature of less than about 1300° C. In one embodiment, the graphite forms at a temperature of less than about 1200° C.

In one embodiment, the isolating graphite comprises collecting the graphite for future sale.

In one embodiment, the solid carbon is added in an oxygen free environment. “Oxygen free environment” means an environment comprising less than about 5%, 4%, 3%, 2%, or 1% oxygen. In one embodiment, “oxygen free environment” means an environment that comprises no measurable oxygen.

In one embodiment, the method does not produce steel.

In one embodiment, the method is carried out in a phosphorous free environment. “Phosphorous free environment” means an environment comprising less than about 5%, 4%, 3%, 2%, or 1% phosphorous. In one embodiment, “phosphorous free environment” means an environment that comprises no added phosphorous.

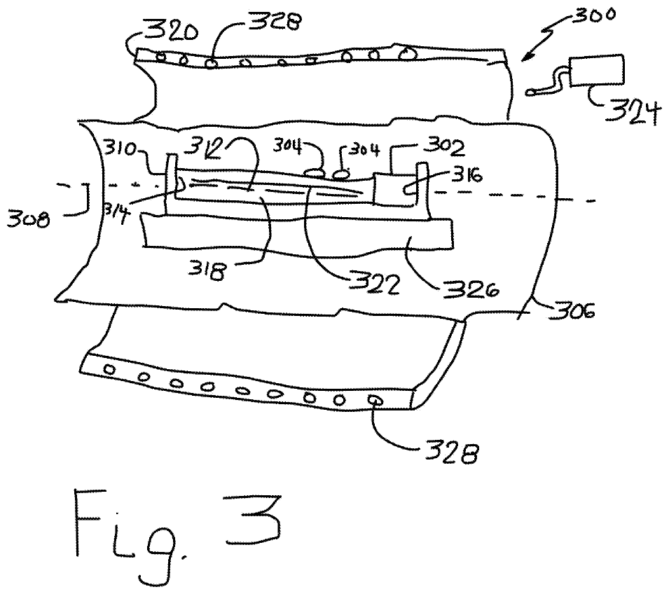

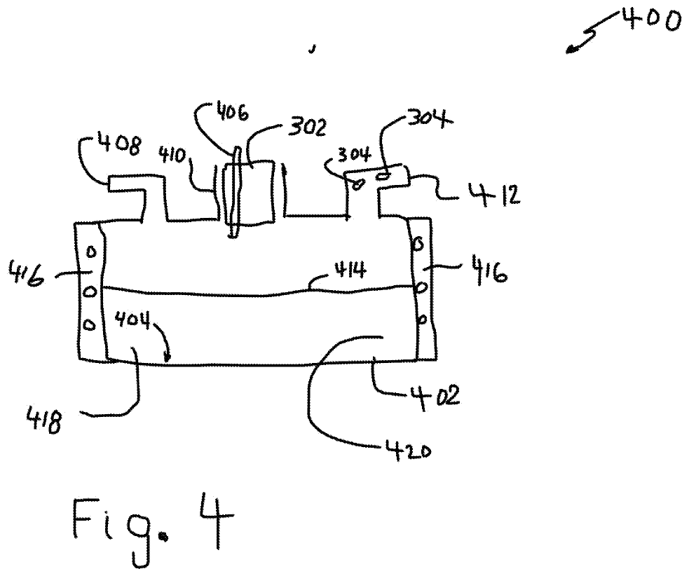

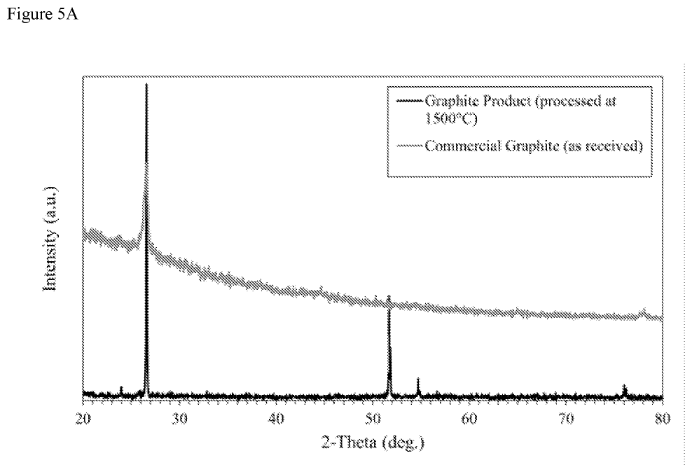

FIG. 3 shows an illustration of an apparatus 300 for converting a solid carbon source 302 to highly crystalline graphite 304 in accordance with some embodiments of the present disclosure. The apparatus 300 includes a tube 306 having a horizontal tube axis 308, a crucible 310, and a heating unit 320.

Crucible 310 has a horizontal crucible axis 312 substantially aligned with the horizontal tube axis 308. Crucible 310 has a first crucible end 314 and a second crucible end 316. The crucible 310 is positioned substantially within the tube 306. In some embodiments, the tube 306 includes quartz.

In operation, the crucible 310 holds a metal 318 and the solid carbon source 302. The metal 318 is not limited to a particular metal. In some embodiments, the metal 318 is nickel. The solid carbon source 302 is not limited to a particular type of carbon. Slag, solid carbon, and charcoal are suitable for use as the solid carbon source 302. The heating unit 320 generates a temperature gradient 322 along the horizontal crucible axis 312. In some embodiments, the temperature gradient 322 decreases from the first crucible end 314 to the second crucible end 316. The temperature gradient 322 is not limited to a particular mathematical function or shape. In some embodiments, the temperature gradient is linear. The highly crystalline graphite 304 is produced near the second crucible end 316. In some embodiments, the highly crystalline graphite 304 is scooped from the crucible 310.

In some embodiments, the apparatus 300 further includes a gas source 324 coupled to the tube 306 to supply an inert gas to the tube 306 and prevent the highly crystalline graphite 304 from reacting with oxygen or another element. The apparatus 300 is not limited to use with a particular inert gas. In some embodiments, the inert gas is nitrogen, N₂.

The heating unit 320 is not limited to a particular type of heating unit. In some embodiments, the heating unit 320 includes a refractory brick 326 thermally coupled to the crucible 310 and an induction heating coil 328 inductively coupled to the refractory brick 326. The tube 306 is located substantially within the induction heating coil 328.

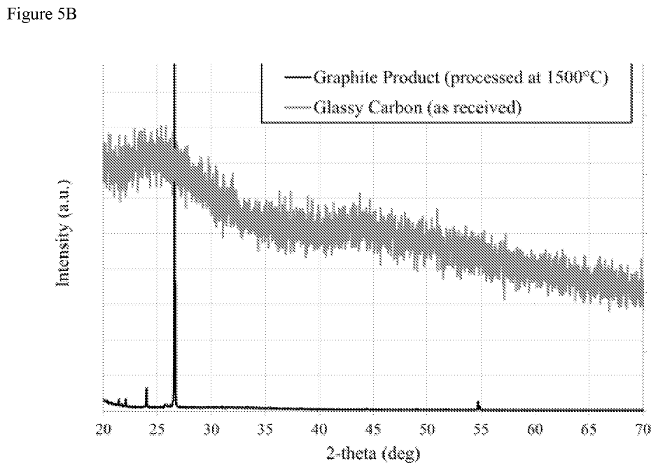

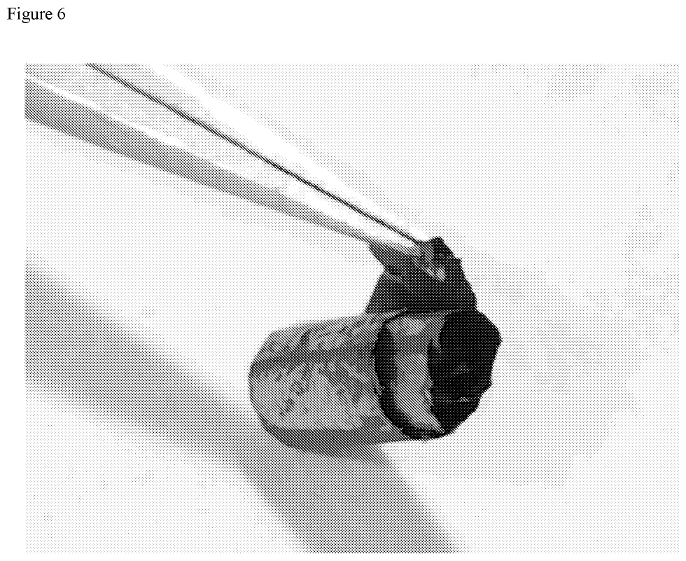

FIG. 4 shows an illustration of an apparatus 400 for converting a solid carbon source 302 to a highly crystalline graphite 304 in accordance with some embodiments of the present disclosure. The apparatus 400 comprises a reactor 402 including a vessel 404 and a carbon heating element 406. The vessel 404 has a first input port 408 to receive nitrogen and the carbon heating element 406 is included to provide energy to liquify the solid carbon source 302. A second input port 410 is provided to receive the solid carbon source 302, and an output port 412 is provided to deliver nitrogen and the highly crystalline graphite 304 as outputs of the apparatus 400. The vessel 404 is provided to hold a solid metal 414 to be liquified. A heating unit 416 is included to provide a temperature gradient within the vessel 404. The heating unit 416 is not limited to a particular type of heating unit. In some embodiments, the heating unit 416 provides energy to heat the contents of the vessel 404 through induction.

In some embodiments, the heating unit 416 provides a temperature gradient having a temperature from about 1700 degrees Centigrade at a high temperature section of the vessel 404 to about 1300 degrees Centigrade at a low temperature section 420 of the vessel 404. In some embodiments, the low temperature section 420 of the vessel 404 is closer to the output port 412 than the high temperature section 418 of the vessel 404.

In operation, nitrogen is delivered to the vessel 404 at the input port 408. The solid carbon source 302 is delivered to the vessel 404 through the second input port 410. The carbon heating element 406 liquifies the solid carbon source 302. The heating unit 416 provides a temperature gradient in the vessel 404. The liquified carbon source 302 and the solid metal 414 are heated in the vessel 404 along the temperature gradient. Highly crystalline graphite 304 and nitrogen are output through the output port 412.

The invention will now be illustrated by the following non-limiting Examples.

### EXAMPLES

### Example 1

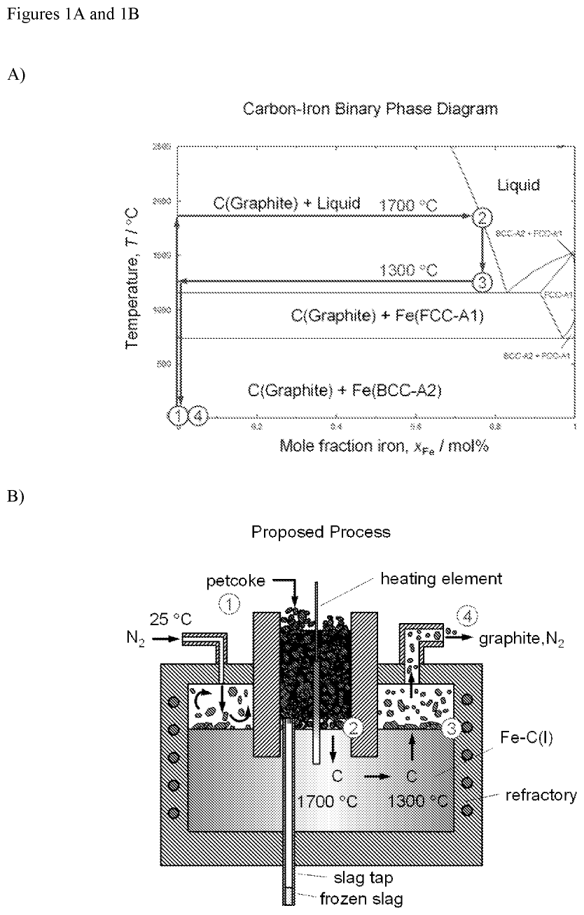

Graphite having high purity (99.99 at % C) and high crystallinity (99% graphitic) is prepared from low-grade, petroleum coke (petcoke) by dissolving the carbon into molten iron alloy containing silicon at temperatures above the liquidus (˜1700° C.) in one chamber, and providing it a pathway to diffuse into a second chamber held at lower temperature (˜1300° C.), where the carbon will precipitate out of the melt in the form of high purity graphite crystals, leaving behind petcoke impurities as slag (FIG. 1b). This process takes advantage of the low activation barrier and over million-times faster carbon mobility in a molten iron solvent (Eₐ˜41 kJ/mol and D˜6.0×10⁻⁵ cm²/s at 1550° C.), allowing production of graphite from petcoke using less than 5 GJ/t of energy and emitting less than 0.5 t/t CO₂ (assuming U.S. grid power mix) at a cost less than 500 $/t graphite.

### Example 2

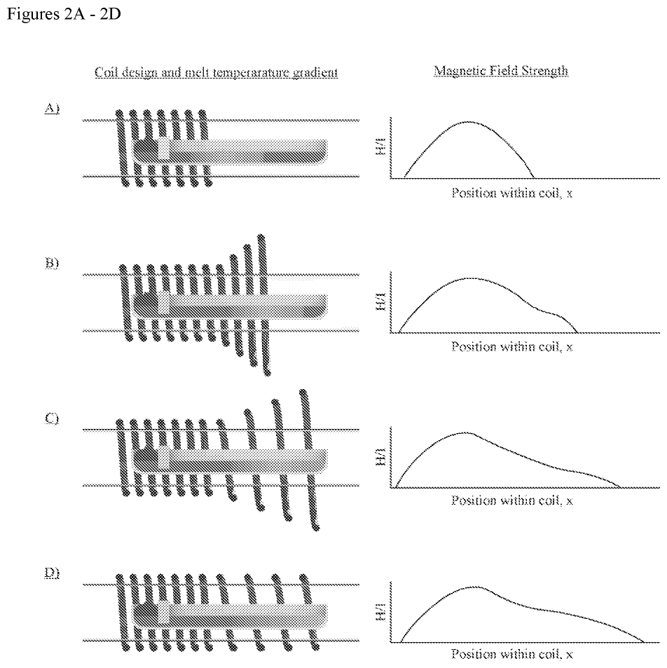

A semi-continuous process can be carried out in a system is able to intermittently receive a carbon source at the feed end of the crucible, while simultaneously being able to remove purified graphite from the product end of the crucible. The temperature gradient in the reactor is important. High temperature at the feed end is required for fast dissolution of carbon and subsequent diffusion into the melt. The temperature of the carbon saturated production end of the crucible needs to be maintained between the liquidus and eutectic freezing temperatures of the binary system. Therefore, it is necessary to control both the feed and the production end temperatures at specific and distinct values. This can be achieved by the coil design illustrated in FIG. 2. The magnetic field strength inside the coil, and the heat induced in the melt, is proportional to the coil diameter and pitch. Various coil designs, their temperature gradients, and their magnetic field strengths within the coil are visualized below. They include coils of A) constant pitch and constant diameter, B) constant pitch and varying diameter, C) varying pitch and varying diameter, and D) varying pitch and constant diameter.

### Example 3

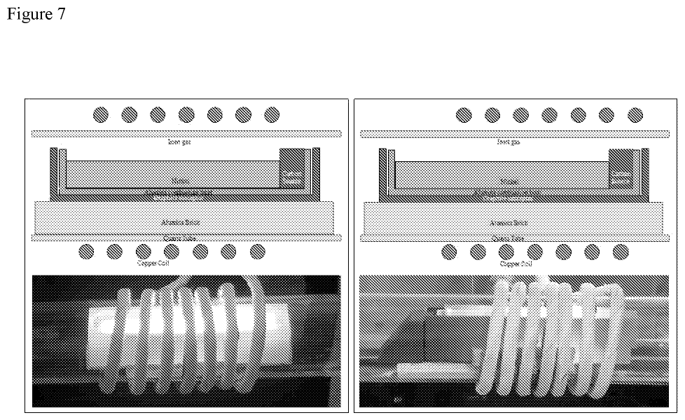

A horizontal furnace was implemented to increase graphite yield (FIGS. 2-4 and 7). The horizontal configuration of the sample in the induction coil allows for a larger surface area for collection on the product side of the reactor. The horizontal design also allows for greater control of the temperature gradient than the previous vertical system. The sample can be moved into or out of the hot zone. A direct correlation of the effect of sample position within the coil and its external magnetic field with the overall effect of graphite formation in the melt was observed.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A method for preparing graphite comprising:
a) adding a solid carbon source to a molten metal to provide a solution that comprises dissolved carbon at a first temperature;
b) reducing the temperature of all or part of the solution under conditions that allow graphite to form; and
c) isolating the graphite.

2. The method of claim 1, which comprises:
providing a molten metal having a temperature gradient that comprises a hot zone having a first temperature and a cooler zone having a second temperature that is below the temperature of the hot zone;
adding a solid carbon source into the hot zone; and
isolating graphite that forms in the cooler zone.

3. The method of claim 1, which comprises:
maintaining a first chamber at a first temperature;
maintaining a second chamber at a second temperature that is below the first temperature, the second chamber having a path to the first chamber.
adding a solid carbon source to molten metal in the first chamber to provide a solution.
allowing the solution to pass through the path from the first chamber to the second chamber; and
isolating graphite from the second chamber.

4. The method of claim 1, wherein the graphite is at least 99% carbon.

5. The method of claim 1, further comprising removing one or more impurities from the graphite to provide graphite is at least 99% carbon.

6. The method of claim 4, wherein the graphite that is at least 99% carbon and comprises graphite crystals.

7. The method of claim 4, wherein the graphite that is at least 99% carbon is at least 99% graphitic.

8. (canceled)

9. The method of claim 1, wherein the solid carbon source comprises petroleum coke.

10. The method of claim 1, wherein the molten metal comprises iron, silicon, nickel, copper, germanium, manganese, bismuth or silver, or a mixture thereof.

11. The method of claim 1, wherein the molten metal is a molten iron alloy.

12. The method of claim 1, wherein the molten metal comprises iron, silicon, or nickel, or a mixture thereof.

13-18. (canceled)

19. The method of claim 1, further comprising packaging the graphite for transport or for sale.

20. (canceled)

21. An apparatus for converting a solid carbon source to a highly crystalline graphite, the apparatus comprising:
a tube having a horizontal tube axis;
a crucible having a horizontal crucible axis substantially aligned with the horizontal tube axis, the crucible having a first crucible end and a second crucible end, the crucible positioned substantially within the tube, and the crucible to hold a metal and the solid carbon source; and
a heating unit to generate a temperature gradient along the horizontal crucible axis, the temperature gradient to decrease from the first crucible end to the second crucible end, the highly crystalline graphite to be produced at the second crucible end.

22. The apparatus of claim 21, further comprising a gas source coupled to the tube to supply an inert gas to the tube.

23. The apparatus of claim 22, wherein the tube comprises quartz.

24. The apparatus of claim 23, wherein the heating unit comprises a refractory brick thermally coupled to the crucible and an induction heating coil inductively coupled to the refractory brick, the tube located substantially within the induction heating coil.

25. An apparatus for converting a solid carbon source to a highly crystalline graphite, the apparatus comprising:
a reactor including a vessel and a carbon heating element, the vessel having a first input port to receive nitrogen and the carbon heating element to provide energy to liquify the solid carbon source, a second input port to receive the solid carbon source, and an output port to deliver nitrogen and the highly crystalline graphite, the vessel to hold a solid metal to be liquified; and
a vessel heating unit to provide a temperature gradient within the vessel.

26. The apparatus of claim 25, wherein the vessel heating unit to provide the temperature gradient having a temperature from about 1700 degrees Centigrade at a high temperature section of the vessel to about 1300 degrees Centigrade at a low temperature section of the vessel.

27. The apparatus of claim 26, wherein the low temperature section of the vessel is closer to the output port than the high temperature section of the vessel.

28-30. (canceled)

31. The method of claim 1, which is carried out in an oxygen free environment.

32-33. (canceled)
